(19) United States
(12) Patent Application Publication
(10) Pub. No.: US 2011/0066624 A1
(43) Pub. Date: Mar. 17, 2011

(54) SYSTEM AND METHOD OF GENERATING RELATED WORDS AND WORD CONCEPTS

(76) Inventor: Divyank Turakhia, Mumbai (IN)

(21) Appl. No.: 12/445,412

(22) PCT Filed: Jul. 31, 2007
(86) PCT No.: PCT/IN07/00325

§ 371 Date: Nov. 30, 2010

(30) Foreign Application Priority Data
Aug. 1, 2006 (IN) 1215/MUM/2006

(51) Int. Cl. G06F 17/30

(52) U.S. Cl. 707/748; 707/E17.044

(57) ABSTRACT

a method and system for generating related keywords based by creating relationship maps using meta keyword appearing on web pages. The present invention also relates to filtering techniques that may be deployed to reduce the skew that may be caused by inserting unrelated meta keywords under web pages.

### FIELD OF INVENTION

The present invention relates generally to a method and system for keyword generation and more specifically to a method and system for building a comprehensive list of related words, phrases and word concepts.

### BACKGROUND OF THE INVENTION

Online search, search engine optimization, internet traffic monetization programs such as domain monetization programs, are some of the areas that make use of keywords and related keywords. For instance a user browsing the Internet may use a keyword, generally defined to mean a phrase or a collection of one or more words, to search on a search engine. The search engine may display related keywords to the user in order to provide a better search experience and/or use words related to the keyword searched to display more accurate results. Recently, Internet traffic monetization has evolved to be a lucrative business where advertisements, commercial content, and keywords that would generate advertisements and/or commercial content and/or direct links to advertisers, are displayed on web pages that users tend to visit. An internet traffic monetization program may use keywords to display advertisements, commercial content, and/or direct links to advertisers on a webpage. In order to obtain more relevant advertisements, Internet traffic monetization program may need to obtain a list of keywords and word concepts related to what the user may be looking out for on a specific web page. The correct choice of keywords and displaying related keywords becomes an essential requirement while optimizing web pages in Internet traffic monetization programs. Hence, there is a need to create a tool that provides keywords and word concepts related to keywords searched or used and specifically keywords and word concepts of commercial importance to help alleviate the problems experienced by Internet users.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a prior art flow diagram of a conventional web crawler used for an embodiment of the present invention.

FIG. 2 illustrates a flow diagram of a method of building relationship between meta keywords in accordance with various embodiments of the present invention.

FIG. 3 illustrates a system diagram of an embodiment of the present invention.

FIG. 4 illustrates a flow diagram of filters applied in accordance with various embodiments of the present invention

### DETAILED DESCRIPTION OF THE INVENTION

Before describing in detail embodiments that are in accordance with the present invention, it should be observed that the embodiments reside primarily in combinations of method steps and apparatus components related to system and method of generating related words and word concepts. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that embodiments of the invention described herein may be comprised of one or more conventional processors and unique stored program instructions that control the one or more processors to implement, in conjunction with certain non-processor circuits, some, most, or all of the functions of a system and method of generating related words and word concepts described herein. The non-processor circuits may include, but are not limited to, a radio receiver, a radio transmitter, signal drivers, clock circuits, power source circuits, and user input devices. As such, these functions may be interpreted as steps for method of generating related words and word concepts described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

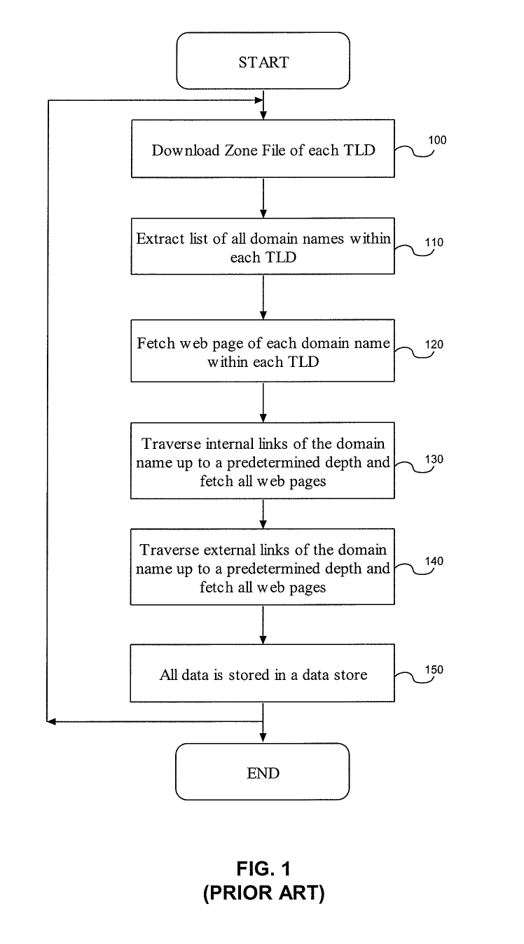

Referring now to FIG. 1 illustrates a prior art flow diagram of a conventional web crawler that crawls web pages on the Internet pursuant to an embodiment of the present invention. The web crawler crawls through web pages of websites existing on the Internet. Such a list may be obtained from various sources. In one embodiment the web crawler may populate an initial list of websites to crawl by downloading a zone file from each top level domain (“TLD”) registry. For instance, the web crawler may download the zone file of the “.com” registry from Verisign. The zone file comprises a list of active domain names operating within that TLD. The list prepared can be termed as a crawl list which is updated frequently by downloading the zone file on a periodic basis, Step 100.

The web crawler extracts the domains names from each TLD and fetches web pages under each domain name, Step 110. The crawler repeats the process for all active domain names under each TLD, Step 120. On fetching the web page, the crawler can parse each web page and extract information from the web page. As per one embodiment of the present invention, the web crawler extracts meta keywords listed under theta tags from all web pages under every domain name crawled by the web crawler. A meta tag is a Hypertext Markup Language (HTML) tag which provides information about a web document. Unlike regular HTML tags, meta tags do not provide formatting information for the web browser. Instead they provide such information as the author, date of creation or latest update for the page, and keywords which indicate the subject matter of the web page. A meta keyword constitutes a part of the meta tag and as stated previously, provides information pertaining the content and context of each webpage. A web page may comprise two types of links—internal links and external links. An internal link is a link within the same domain name while an external link is generally a link to another domain name, outside the current domain. The external links are parsed to extract the domain name portion, and the extracted domain names along with the external links are then further added to the crawl list. The web crawler traverses both internal links and external links to obtain a list of meta keywords for each web page on the world wide web, Step 130 and Step 140. In some instances, the web crawler can be restricted to a certain depth for traversing number of links on each web page. The crawling process can be repeated regularly to continuously update data. All data is stored in a data store, step 150. The web crawler now hands over the analysis process to a relationship generator 310.

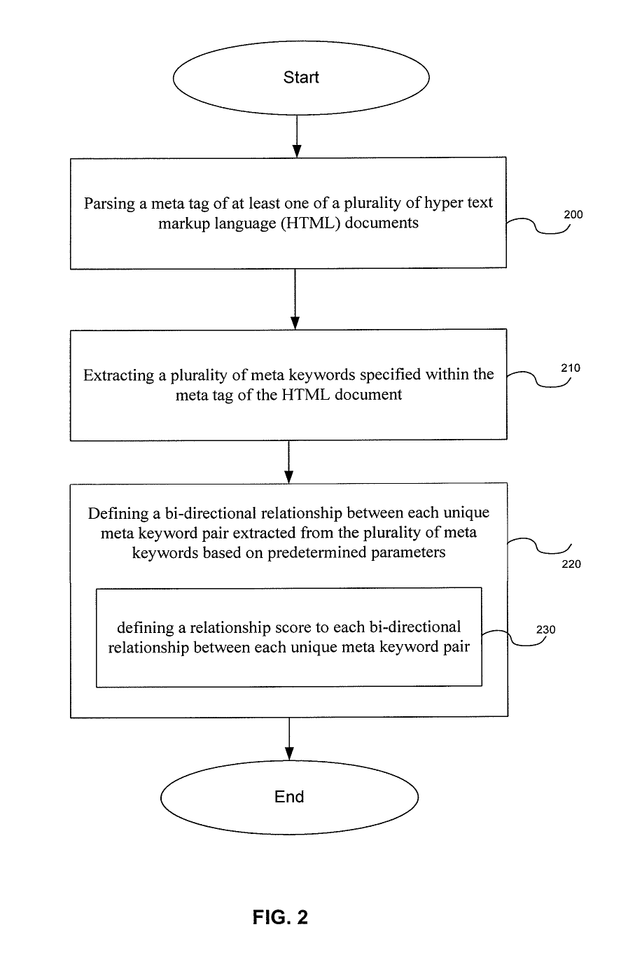

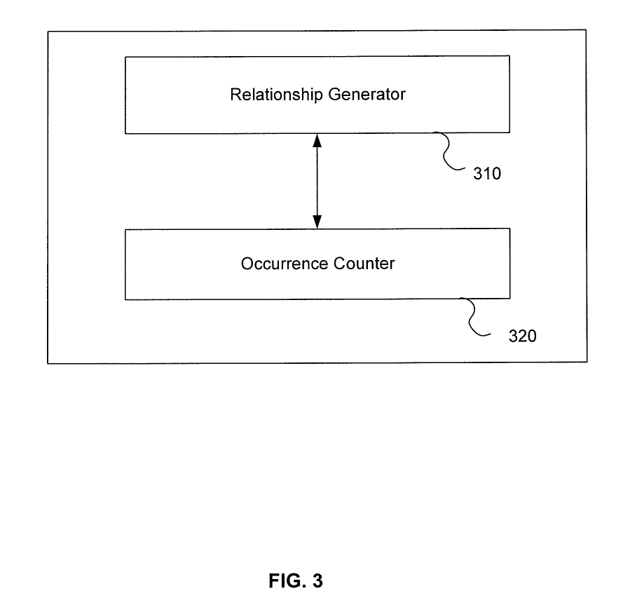

Turning now to FIG. 2 and FIG. 3, where FIG. 2 illustrates a flow diagram of a method followed by the relationship generator 310 in accordance with various embodiments of the present invention and FIG. 3 illustrates a system level diagram pursuant to an embodiment of the present invention. As per one embodiment of the present invention, the relationship generator 310 can initially parse a meta tag of at least one of a plurality of HTML documents, Step 200 and extracts a plurality of meta keywords from the HTML document, Step 210. The relationship generator 310 is configured to parse the meta tag of each HTML document on each website on the Internet. On retrieving the meta keywords from the meta tag, the relationship generator 310 defines a bidirectional relationship between each pair of meta keyword per webpage, Step 220. The relationship generator 310 can ensure that each pair of meta keywords are unique within the meta tag of each HTML document. For instance, if a list of meta keywords extracted from a webpage comprises “online finance”, “mortgage” and “loans”, the relationship generator 310 creates a map which specifies that “online finance” is related to “mortgage” as well as “loans”, “mortgage” is related to “online finance” as well as “loans” and “loans” is related to “online finance” as well as “mortgage”. A relationship score is maintained for each relationship established between keywords. Similarly, every meta keyword list extracted from other webpages can be analyzed and relationships can be established in a similar manner. When the same meta keywords are found on a different webpage, the relationship score between those meta keywords can be increased. As per one embodiment, those skilled in the art shall appreciate that the relationship score is incremented only if the unique meta keyword pair extracted from one HTML document is found in another HTML document. The relationship generator 310 is free to discard certain HTML documents as well if the HTML document is substantially similar to a previous HTML document or if the HTML document is hosted on the same IP or subnet as another HTML document as described in greater detail below. Greater the relationship score, greater is the probability that the two meta keywords are related since a greater number of web pages are specifying similar sets of meta keywords for describing the content on a webpage.

As an example, let us assume an initial scenario where a web page has content related to cars. Meta keywords are inserted within meta tags on each web page to describe the content on the webpage. For example, a web page of a domain name may contain meta keywords such as “best car deals”, “car insurance”, “used cars” and “cars loans” within meta tags. The meta key words generally illustrate the kind of content to be found on the web page and is generally intended to be used by search engines such as Google, Yahoo etc. to list the web page on a search engine results page generated when a user searches for a word specified in the meta keywords. Now when the web crawler has extracted the meta keywords from the webpage, the relationship generator 310 shall create a map where each meta keyword shall have a single bidirectional relationship with another meta keyword extracted from the web page. Hence, for instance, “best car deals” shall have a single bidirectional relationship with “car insurance”, “used cars” and “car loans”, “car insurance” shall have a single bidirectional relationship with “used cars” and “car loans”, and “used cars” shall have a single bidirectional relationship with “car loans”. A bidirectional relationship shall mean “best car deals” is related to “car insurance”, “used cars” and “car loans” and each one of them are independently related to “best car deals” as well. Now, another webpage relating to car finance may insert meta keywords such as “car insurance”, “car loans” and “car interest rates” within its meta tags. Following a similar process as specified above, the relationship score for “car insurance” to “car loans” shall increment to two, since two web pages listing “car insurance” and “car loans” as meta keywords were found. Greater the relationship score, greater is the probability that the two words are related since a greater number of web pages are specifying similar sets of meta keywords for describing the content on a webpage. The relationship generator 310 shall traverse all meta keywords extracted by the web crawler and create a bidirectional relationship and build a relationship score for the entire Internet that the web crawler was able to crawl. The relationship map can be periodically updated based on the meta keywords extracted each time. Several parameters can be considered while determining the relationship score between meta keywords. For instance, the distance between meta keywords, where meta keywords closers to each other on a web page can be given a higher relationship score as opposed to meta keywords at a greater distance from each other. Also, the importance of a particular webpage can be used i.e. relationships formed by meta keywords on web pages with higher importance can be given a higher weightage as opposed to relationships formed by meta keywords from web page with lower importance. Importance of a web page can be determined by using any of the many commonly known methods available to rank the importance of a web page on the internet as known in the art.

Another method can be creating relationships between meta keywords of two pages that are linked to each other. For instance, meta keywords specified on a web page at a depth of one hyperlink from another webpage can be given a higher weightage while calculating relationship score as opposed to a web page that is at a depth of five hyperlinks from the webpage. In one embodiment, only a predetermined number of meta keywords, for instance the first twenty, on each web page may be considered for building relationships. Since meta keywords are not case sensitive, web pages generally specify meta keywords in lower, upper or mixed letter case. Hence, the letter case/capitalization of acronyms such as “ufo” or certain case sensitive words such as names of companies may not be represented correctly within meta keywords. In order to understand the correct representation of a meta keyword, the letter case of all words in the web page content that were found as meta keywords while crawling the Internet, can be stored and used to determine the correct letter case representation of each meta keyword. Those skilled in the art shall appreciate that the different parameters specified are merely exemplary and shall not be construed as being the only parameters to be taken into consideration while building relationship scores. The present invention shall have the full scope of the claims.

As per another embodiment, while creating relationships between meta keywords, building relationship scores or building occurrence counts, the relationship generator 310 may also adjust relationships, relationship scores and occurrence counts using the IP address of the crawled webpage and/or the subnet of the crawled webpage that is being used to build such relationships, relationship scores or occurrence counts. A subnet is a portion of a network that shares a common address component. The filtering process may be carried out to reduce or eliminate skews while building relationships between meta keywords.

For instance, a web page may have a random set of meta keywords, that may not be related to the content of the webpage nor to each other, in order to obtain a high ranking on a search engine or for visibility of the webpage or due to a human error etc. Now, while generating relationships, filtering based on the IP address of the web page may reduce the skew that such a web page may cause while these web pages are hosted under a single IP address or more so under a single subnet. For example, in one embodiment, the relationship score count assigned to two meta keywords may be proportionately increased if both those meta keywords appear as meta keywords on two different webpages hosted on two different IP addresses or subnets. Similarly, the relationship score may be proportionately reduced if the meta keywords appear on web pages on the same IP address or the same subnet. Such filtering mechanisms may help alleviate the skew that may be caused by miscreants. Those skilled in the art shall appreciate that various filtering techniques that may help reduce the skew may also be deployed and such filtering techniques are within the scope of the present invention.

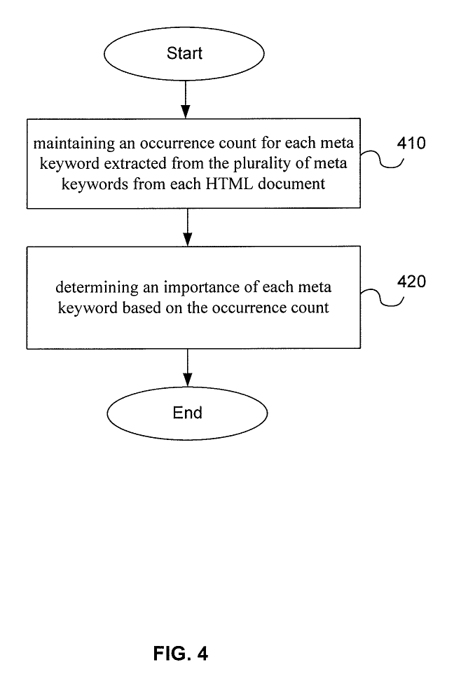

The relationship generator 310 creates relationships between meta keywords and increases the relationship score every time two related meta keywords are found listed under another webpage. The occurrence counter 320 on the other hand keeps track of the number of times a meta keyword appears within the meta tag of each HTML document parsed. The relationship generator and the occurrence counter can be part of a single module on a computing system. FIG. 4 describes the process of keeping occurrence counts and using the occurrence count to increase accuracy in building relationships.

Turning now to FIG. 4, illustrates a flow diagram of a method of building and using occurrence counts in accordance with various embodiments of the present invention. As disclosed above, the relationship generator 310 builds relationship maps using meta keywords specified under each webpage to obtain words related to words. Now, the occurrence counter 320 generator shall maintain a track of the number of times a keyword appeared as a meta keyword in the web pages crawled by the web crawler. Keeping track of the occurrence count shall provide an estimate of the importance of the meta keyword as opposed to other meta keywords. For instance, the relationship generator 310 may provide a list of related keywords to a keyword, however, the occurrence count generator shall be able to list the related keywords in order based on the occurrence count. Occurrence count too, like relationship score, can be based on weights depending on importance of the web page etc as described in FIG. 2. Two keywords having an equal relationship score with a keyword can be ordered based on the occurrence counts. As per one embodiment, if the occurrence count of a keyword is less than a predetermined amount, the keyword can be eliminated to reduce the skew.

The advantage offered by an embodiment of the present invention is language independence. Since the relationship generator 310 does not need to know the language of the meta keywords in order to build relationships, keywords related to other keywords can be found for any language merely based on its occurrence on the Internet. Another advantage is the ability to find related words that may be commercially more relevant for web service companies, advertising companies, search engine companies etc. Tools such as the Thesaurus provide synonyms and not actually words that may be related to other words. The present invention builds a dictionary equivalent of words and their related words of all words that have been specified on the Internet. The present invention also obtains brand names and related words of the brand name and related brand names, for instance searching for “DKNY” may display related words such as “Women Clothing”, “Jeans”, “Jackets”, “Shoes”, “Handbags” etc and will also show up related brand names such as “GUCCI”, “Armani”, “Prada”, “Chanel” etc. Popular misspellings and their related words can also be obtained using the present invention. Those skilled in the art shall appreciate that the abovementioned advantages are in no way comprehensive and shall not be construed to represent the only advantages offered by the present invention. The scope of the invention shall be afforded the full scope of the claims contained herein.

The relationship map provides substantially accurate data while searching for related words. The relationship map shall also provide a comprehensive dictionary of words having commercial value on the Internet. While a Thesaurus may provide synonyms to a word and may not provide any value, for instance, a Thesaurus may never provide synonyms for “car finance” and may provide synonyms such as “automobiles”, “van”, “vehicle” for words such as cars, while the relationship generator 310 may provide words such as “car insurance”, “used cars”, “car loans” as words related to cars. Such related words shall have a greater commercial value and may even be more relevant. For instance, search engines may be able to target more relevant results based on a web users search, search engines will be able to display related keywords more accurately to web users thus improving the user experience, an internet traffic monetization provider may be able to target more relevant advertisements, commercial content and keywords that help generate advertisements, commercial content and/or direct links to advertisers, on the web page and a website may be able to obtain better visibility by inserting relevant help generate advertisements, commercial content and/or direct links to advertisers, on the web page and a website may be able to obtain better visibility by inserting relevant meta keywords. Those skilled in the art shall appreciate that the uses of the present invention are not limited only to the examples above and can be used in any industry across any vertical using related words.

What is claimed is:

1. A method of establishing keyword relationships, the method comprising:
parsing a meta tag of at least one of a plurality of hyper text markup language (HTML) documents, the meta tag comprising a set of meta keywords; and
extracting a plurality of meta keywords specified within the meta tag of the HTML document; and
defining a bi-directional relationship between each unique meta keyword pair extracted from the plurality of meta keywords based on predetermined parameters.

2. The method of claim 1, wherein the defining step further comprises:
defining a relationship score to each bi-directional relationship between each unique meta keyword pair.

3. The method of claim 2, wherein the relationship score is incremented if the unique meta keyword pair exists in at least one other HTML document.

4. The method of claim 2, wherein the predetermined parameters comprises at least one of:
an importance of the HTML document;
a depth of the HTML document within a website;
an internet protocol (IP) address of the website from where the HTML document has been retrieved; and
a subnet of the website from where the HTML document has been retrieved.

5. The method of claim 1 further comprises:
maintaining an occurrence count for each meta keyword extracted from the plurality of meta keywords from each HTML document.

6. The method of claim 5 wherein the occurrence count is used to determine an importance of each meta keyword.

7. The method of claim 1, wherein the plurality of HTML documents is at least one of a local intranet network and Internet.

8. The method of claim 4, wherein a predetermined set of meta keywords can be chosen from the meta tag of the each HTML document.

9. A system for establishing keyword relationships, the system comprising:
a relationship generator, the relationship generator configured for
parsing a meta tag of at least one of a plurality of hyper text markup language (HTML) documents, the meta tag comprising a set of meta keywords; and
extracting a plurality of meta keywords specified within the meta tag of the HTML document; and
defining a bi-directional relationship between each unique meta keyword pair extracted from the plurality of meta keywords based on predetermined parameters.

10. The system of claim 9, wherein the relationship generator is further configured to define a relationship score to each bi-directional relationship between each unique meta keyword pair.

11. The system of claim 10, wherein the relationship generator increments the relationship score if the unique meta keyword pair exists in at least one other HTML document.

12. The method of claim 9, wherein the predetermined parameters comprises at least one of:
an importance of the HTML document;
a depth of the HTML document within a website;
an internet protocol (IP) address of the website from where the HTML document has been retrieved; and
a subnet of the website from where the HTML document has been retrieved.

13. The system of claim 9 further comprises:
An occurrence counter, the occurrence counter configured for
maintaining an occurrence count for each meta keyword extracted from the plurality of meta keywords from each HTML document.

14. The system of claim 13 wherein the occurrence counter is used to determine an importance of each meta keyword.

15. The system of claim 13, wherein the occurrence counter and the relationship generator form part of a single module.
